(19) United States
(12) Patent Application Publication
(10) Pub. No.: US 2015/0038241 A1
(43) Pub. Date: Feb. 5, 2015

(54) Discontinuous Shaft Assembly for a Field Device

(71) Applicant: General Equipment and Manufacturing Company, Inc., d/b/a TopWorx, Inc.., Louisville, KY (US)

(72) Inventors: Jason S. Jennings, Jeffersonville, IN (US); Michael Simmons, Louisville, KY (US)

(73) Assignee: General Equipment and Manufacturing Company, Inc., d/b/a TopWorx, Inc.., Louisville, KY (US)

(21) Appl. No.: 14/448,885

(22) Filed: Jul. 31, 2014

Related U.S. Application Data
(60) Provisional application No. 61/861,353, filed on Aug. 1, 2013.

(51) Int. Cl. H02K 7/00; F16D 27/02

(52) U.S. Cl. CPC H02K 7/003; F16D 27/02
USPC 464/29

(57) ABSTRACT

A discontinuous shaft assembly includes a first shaft arranged for rotation about a first axis and including an end arranged for placement adjacent the wall at a first desired location disposed on a first side of the wall, with a magnetic portion carried by the first shaft. The assembly also includes a second shaft arranged for rotation about a second axis and including an end arranged for placement adjacent the wall of the enclosure at a second desired location disposed on a second side of the wall, with a magnetic portion carried by the second shaft. The first magnetic portion is arranged to cooperate with the second magnetic portion so that rotation of the first shaft about the first axis causes rotation of the second shaft about the second axis.

### FIELD OF THE INVENTION

This disclosure relates generally to field devices in process control systems and, more particularly, to discontinuous or non-penetrating shaft assemblies for use in such field devices.

### DESCRIPTION OF THE PRIOR ART

Process control systems typically employ a variety of field devices to temporarily store, monitor, or otherwise control the flow of fluids within the process system. These process control systems monitor and/or control various conditions or parameters, such as, for example, fluid flow, fluid pressure, fluid temperature, and/or fluid level. The process control systems typically control or monitor these parameters using a network of field devices, such as control valves, liquid level controllers, or other devices. In response to signals indicating the state of devices within the system, the process control system generates control signals, which are received by the field devices. The field devices then fully or partially open, close, generate feedback signals, or otherwise respond to the control signals to assess or alter the fluid parameters in the manner desired by the process control system.

One common field device is a liquid level controller. Liquid level controllers are typically mounted to a vessel, which may be a pressure vessel. The liquid level controller is mounted to the outside of the vessel, and includes a rotatable shaft that penetrates the vessel and is coupled to a displacer disposed inside the vessel. The displacer moves in response to changes in fluid level, and conveys these changes to the externally mounted controller via changes in the rotational position of the shaft. Based on this information, the liquid level controller conveys signals indicative of the state of the fluid level to the process control system.

Another common field device is a control valve. Such valves typically include a positioner, such as a digital valve positioner, which receives control signals from the process control system and translates the control signal into an output signal to operate an actuator. In turn, the actuator is typically coupled to a control element or other component via a shaft. Consequently, the process control system, via the actuator and the shaft, places the field device in the state desired by the process control system.

In many applications a shaft of the field device must penetrate a housing, which, as outlined above, may be pressurized. In such situations, the penetrating hole must be carefully machined, and the penetrating hole must be appropriately sealed. The machined penetration holes, coupled with precision bearings and durable seals, add to the cost of the field device. Further, seals and bearings tend to have a limited lifespan, which not only increases maintenance costs over time, but also creates a possible leak path or other failure mechanism. Further, if the machined hole, the bearings, or the seal fails, internal components within the enclosure may be subject to contamination and failure; and servicing these internal components can be very costly. A non-penetrating shaft assembly may address one or more of the foregoing concerns.

### SUMMARY

In accordance with a first exemplary aspect, a discontinuous shaft assembly for use with a field device including a wall comprises a first shaft arranged for rotation about a first axis, the first shaft including an end arranged for placement adjacent the wall at a first desired location disposed on a first side of the wall, a magnetic portion carried by the first shaft toward the end of the first shaft, a second shaft, the second shaft arranged for rotation about a second axis, the second shaft including an end arranged for placement adjacent the wall of the enclosure at a second desired location disposed on a second side of the wall, and a magnetic portion carried by the second shaft toward the end of the second shaft. The first magnetic portion is arranged to cooperate with the second magnetic portion so that rotation of the first shaft about the first axis causes rotation of the second shaft about the second axis.

In accordance with a second exemplary aspect, a field device having a discontinuous valve shaft assembly comprises an actuator operatively coupled to a first shaft, a process element operatively coupled to a second shaft, and an enclosure having a wall, with the actuator and the process element disposed on opposite sides of the wall. The first shaft is arranged for rotation about a first axis, with the first shaft including an end arranged for placement adjacent the wall at a first desired location disposed on a first side of the wall. A magnetic portion is carried by the first shaft toward the end of the first shaft. The second shaft is arranged for rotation about a second axis, with the second shaft including an end arranged for placement adjacent the wall of the enclosure at a second desired location disposed on a second side of the wall. A magnetic portion is carried by the second shaft toward the end of the second shaft, and the first magnetic portion is arranged to cooperate with the second magnetic portion so that rotation of the first shaft about the first axis causes rotation of the second shaft about the second axis.

In accordance with a third exemplary aspect, a discontinuous shaft assembly for use with a field device having a wall comprises a first shaft arranged for rotation about a first axis, the first shaft including an end arranged for placement adjacent the wall at a first desired location disposed on a first side of the wall, a magnetic portion carried by the first shaft toward the end of the first shaft, and second shaft arranged for rotation about a second axis, with the second shaft including an end arranged for placement at a second desired location disposed on a second side of the wall. A magnetic sensor is disposed on the second side of the wall, and a motor is operatively coupled to the second shaft and is responsive to movement of the magnetic sensor. The first magnetic portion is arranged to cooperate with the magnetic sensor so that rotation of the first shaft about the first axis causes movement of the magnetic sensor, causing the motor to rotate the second shaft about the second axis.

In further accordance with any one or more of the foregoing first, second, or third aspects, a discontinuous shaft assembly and associated field device may further include, in any combination, any one or more of the following preferred forms.

In one preferred form, the first shaft and the second shaft are arranged with the first axis in alignment with the second axis.

In another preferred form, the first shaft includes a first guide and the second shaft includes a second guide, and the first guide is arranged to maintain the first shaft adjacent the first desired location and the second guide is arranged to maintain the second shaft adjacent the second desired location.

In another preferred form, the first guide engages the end of the first shaft, and the second guide engages the end of the second shaft.

In another preferred form, the magnetic portion of the first shaft is radially offset relative to the first axis and the magnetic portion of the second shaft is radially offset relative to the second axis.

In another preferred form, the first shaft includes a base disposed at the end of the first shaft and the second shaft includes base disposed at the end of the second shaft, and wherein the magnetic portion of the first shaft is carried by the base of the first shaft, and wherein the magnetic portion of the second shaft is carried by the base of the second shaft.

In another preferred form, the base of at least one of the first shaft or the second shaft is disc-shaped.

In another preferred form, the first magnetic portion comprises a first polarity and the second magnetic portion comprises a second polarity.

In another preferred form, the first magnetic portion includes a first array of magnets and the second magnetic portion includes a second array of magnets.

In another preferred form, a first magnet in the first array of magnets has a polarity and is aligned with a corresponding second magnet of the second array of magnets, the corresponding second magnet having an opposite polarity from the first magnet.

In another preferred form, the enclosure is a pressure vessel.

In another preferred form, the axis of the first shaft is offset relative to the axis of the second shaft.

In another preferred form, the magnetic sensor comprises a hall effect sensor.

### BRIEF DESCRIPTION OF THE DRAWINGS

FIG. 1 is an elevational view in cross-section illustrating a field device in the form of a control valve and having a housing or enclosure and incorporating a discontinuous shaft assembly constructed in accordance with the teachings of an exemplary embodiment of the invention.

FIG. 2 is another view of the discontinuous shaft assembly for use in the field device of FIG. 1.

FIG. 3 is an enlarged fragmentary view, partly in section, illustrating portions of the discontinuous shaft assembly in greater detail.

FIG. 4 is another enlarged fragmentary view, partly in section, illustrating portions of the discontinuous shaft assembly constructed in accordance with the teachings of another exemplary embodiment of the invention.

FIG. 5 is a fragmentary perspective view, partly in section, and illustrating another field device in the form of a liquid level controller and having a housing or enclosure and also incorporating a discontinuous shaft assembly constructed in accordance with the teachings of an exemplary embodiment of the invention.

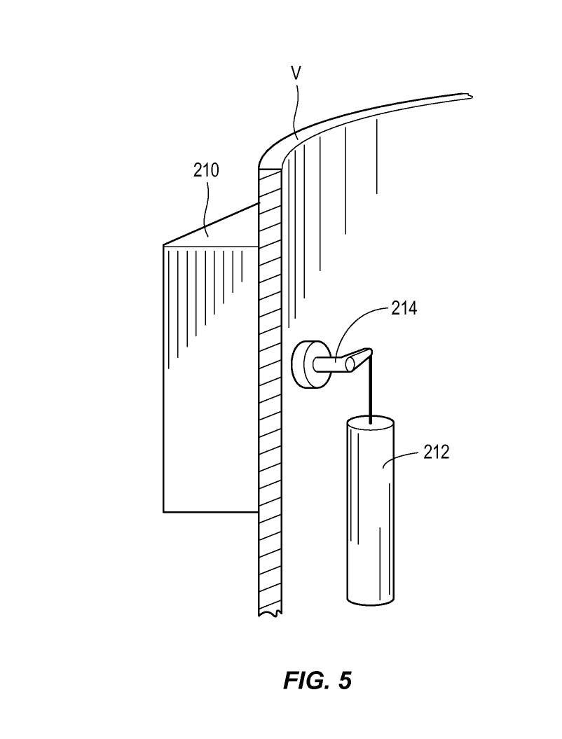

### DETAILED DESCRIPTION

Although the following text sets forth a detailed description of one or more exemplary embodiments of the invention, it should be understood that the legal scope of the invention is defined by the words of the claims set forth at the end of this patent. Accordingly, the following detailed description is to be construed as exemplary only and does not describe every possible embodiment of the invention, as describing every possible embodiment would be impractical, if not impossible. Numerous alternative embodiments could be implemented, using either current technology or technology developed after the filing date of this patent. It is envisioned that such alternative embodiments would still fall within the scope of the claims defining the invention.

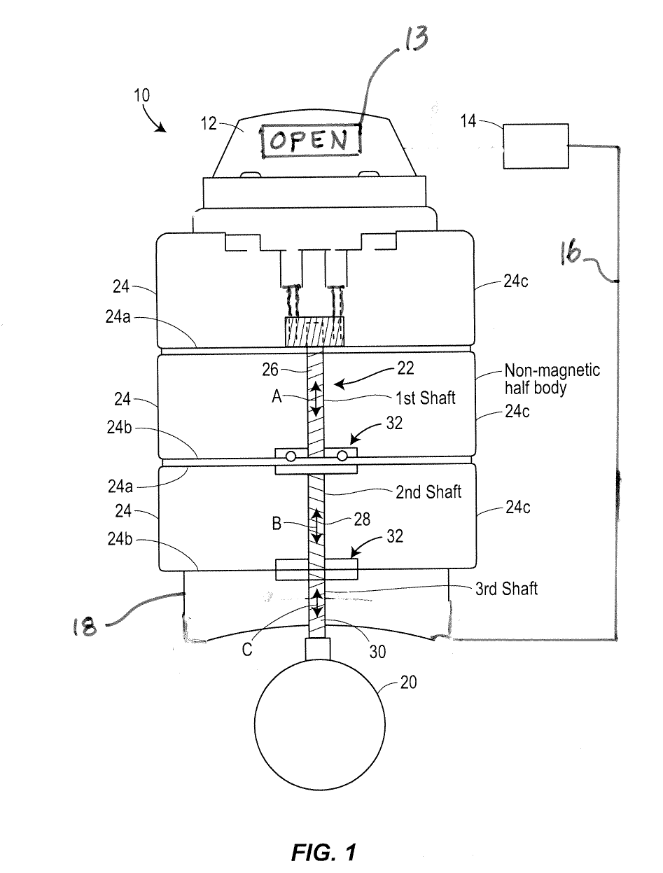

Referring now to the drawings, FIG. 1 shows an exemplary field device 10 having attached thereto a position monitor 12, such as a Valvetop D-Series or T-series switchbox, which is operatively coupled to a process control element 20 via an actuator 18. The actuator 18, which is preferably coupled to a valve controller such as a digital valve controller, may be operatively coupled to a valve controller network 14 through a coupling 16. The coupling 16 may be wired, wireless, or any other suitable coupling. The valve controller is arrange to send signals to and/or receive signals from the process control network 14 via the coupling 16. The actuator 18 of the field device 10 is operatively coupled to the process control element 20 via a coupling 21, which may be a shaft or any other suitable coupling. In the example shown, the field device 10 is a control valve and the process control element 20 is a control element, such as a valve plug, a disc, or any process control element that controls the flow of process fluid through the control valve. The actuator 18 is coupled to the process element 20 via a shaft 30, and is also operatively coupled to the position monitor 12 via a discontinuous shaft assembly 22 assembled in accordance with the present teachings. The position monitor 12 includes an indicator 13, which typically contains indicia to indicate the position of the process control element 20 of the control valve. For example, the indicator will display the indicia “open” when the process control element 20 is in the open position and will display the indicia “closed” when the process control element 20 is in the closed position. The indicator is operatively coupled to the shaft 26, such that movement of the shaft 26 (in response to movement of the actuator 18) causes the indicia of the indicator 13 to move between the “open” and “closed” indications.

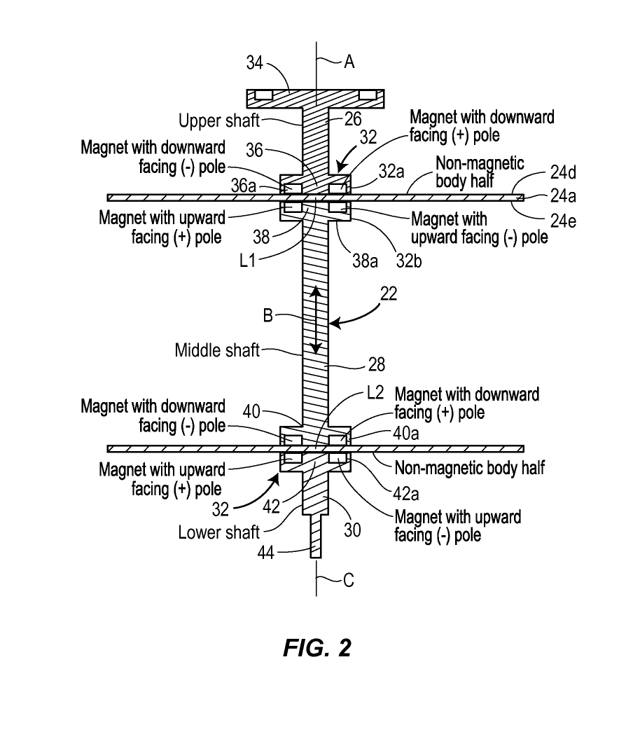

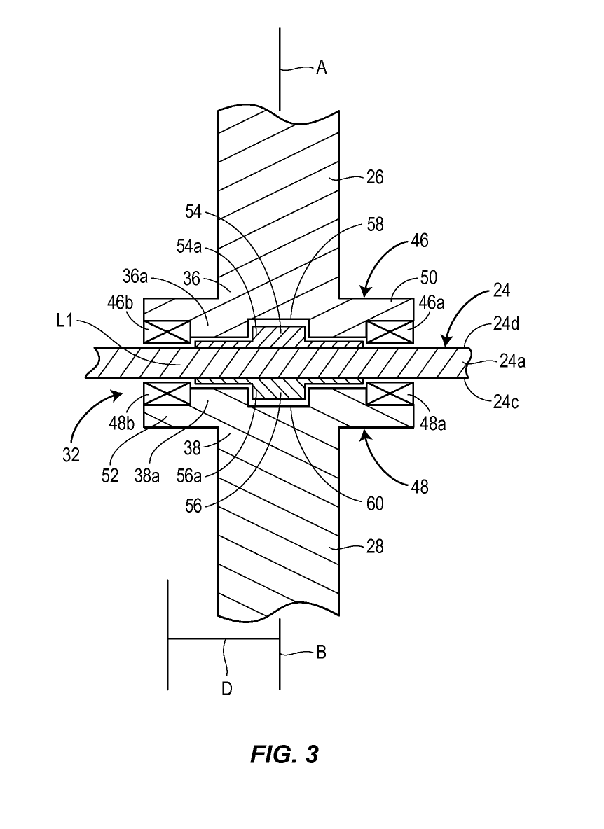

As shown in FIGS. 1 and 2, the discontinuous shaft assembly 22 of the field device 10 typically extends through one or more components of the field device and, in the example shown, extends through one or more enclosures 24. A plurality of enclosures 24 are shown in FIG. 1, and a single enclosure is shown in fragmentary form in FIG. 2. Each of the enclosures 24 includes a top wall 24a, a bottom wall 24b, and a surrounding sidewall 24c (visible only in FIG. 1). Typically, at least the top wall 24a and the bottom wall 24b of the enclosures 24 are non-magnetic. Each of the shafts 26, 28, and 30 are rotatable about rotational axes A, B, and C, respectively, in response to movement of the actuator 18 when the actuator 18 changes the position of the process control element 20. In the example shown, the axes A, B and C of the shafts 26, 28 and 30, respectively, are all in alignment or in substantial alignment with one another. Also, and as shown in the examples of FIGS. 1 and 2, a magnetic coupling 32 joins the first shaft 26 to the second shaft 28, and another magnetic coupling 32 joins second shaft 28 to the third shaft 30. Each magnetic coupling 32 includes an upper portion 32a, and a lower portion 32b. Each of the upper portion 32a and the lower portion 32b includes one or more magnets or magnet arrays. Exemplary details of the magnetic couplings 32 and the magnets/magnetic arrays are shown in FIG. 3 and are described in greater detail below.

Referring now to FIG. 2, the first shaft 26 includes an upper portion 34 operatively coupled to the indicator 13 of the position monitor 12, and also includes a lower portion 36 terminating in an end 36a. Similarly, the second shaft 28 includes an upper portion 38 terminating in an end 38a and a lower portion 40 terminating in an end 40a. Finally, the third shaft 30 includes an upper portion 42 terminating in an end 42a and a lower portion 44 operatively coupled to the process element 20. As shown, the lower portion 36, including the end 36a, of the first shaft 26 is positioned adjacent to an upper or first side 24d of an upper one of the walls 24a at or closely adjacent to a desired location L1, while the upper portion 38, including the end 38a, of the second shaft 28 is positioned adjacent to a lower or second side 24e of the wall 24a, again at or closely adjacent to the desired location L1. The lower portion 40, including the end 40a, of the second shaft 28 is positioned adjacent to the upper or first side 24d of the wall 24a at or closely adjacent to a desired location L2, while the upper portion 42, including the end 42a, of the third shaft 30 is positioned adjacent to the lower or second side 24e of the wall 24a, again at or closely adjacent to the desired location L2. Those of skill in the art will appreciate that the various walls 24a-c may be formed of a single layer or from multiple layers, preferably of low permeability material such as, for example, plastic or non-ferrous metals. By virtue of the magnetic couplings 32, operation of the actuator 18 rotates shaft 30, and via the coupling 32 rotates the shaft 28. By virtue of the other magnetic coupling 32, rotation of the shaft 28 rotates the shaft 26, which in turn causes rotation of the indicator 13. In accordance with exemplary aspect, due to the magnetic couplings 32, rotation of the shafts may be transmitted across the various walls of the enclosure(s) 24 without requiring a penetration through the enclosure wall(s).

Referring now to FIG. 3, the magnetic coupling 32 that operates to transmit rotation from the first shaft 26 to the second shaft 28 is shown in greater detail. Those of skill in the art will understand that the magnetic coupling 32 that joins the shafts 28 and 30 may be the same or substantially similar. The lower end 36a of the first shaft 26 includes a magnetic array 46, while the upper end 38a of the second shaft 28 includes a magnetic array 48. The magnetic array 46 preferably includes a plurality of individual magnets, such as, for example, magnets 46a and 46b. Similarly, the magnetic array 48 also preferably includes a plurality of individual magnets, such as, for example, magnets 48a and 48b. In the example shown, the magnet 46a includes a downward facing positive (+) pole, while the magnet 48a includes an upward facing negative (−) pole. Further, the magnet 46b includes a downward facing negative (−) pole, while the magnet 48b includes an upward facing positive (+) pole. Those of skill in the art will understand that the number of magnets in each magnet array 46 and 48 may vary, and will also understand that the individual magnets may be arranged in any desired orientation as long as each individual magnet in the upper magnetic array 46 is aligned, or is otherwise positioned to magnetically interact, with a corresponding individual magnet in the lower magnetic array 48. In the example shown, the magnetic array 46 is carried by an expanded base 50 formed adjacent the end 36a of the shaft 26, and the magnetic array 48 is carried by an expanded base 52 formed adjacent the end 38a of the shaft 28. In the illustrated example, the expanded bases 50 and 52 are generally disc-shaped, although other shapes may prove suitable. Consequently, in the example shown, the individual magnets 46a, 46b, 48a, and 48b are laterally or radially offset relative to the axes A and B by an offset distance D.

Referring still to FIG. 3, the lower end 36a of the shaft 26 may engage a guide 54, and the upper end 38a of the shaft 28 also may engage a guide 56. In the illustrated construction, the guides 54 and 56 each include a protrusion 54a and 56a, respectively, while the shafts 26 and 28 each include a recess 58, 60, respectively. Other specific constructions may prove suitable. The guides 54 and 56 may be integrally formed with the relevant wall of the enclosure 24. Alternatively, the guides 54 and 56 may be suitably affixed to the wall 24 by welding, adhesives, or any other suitable means. The guides 54 and 56 are arranged to maintain the ends 36a and 38a, respectively, in position at their desired locations L1 and L2, respectively.

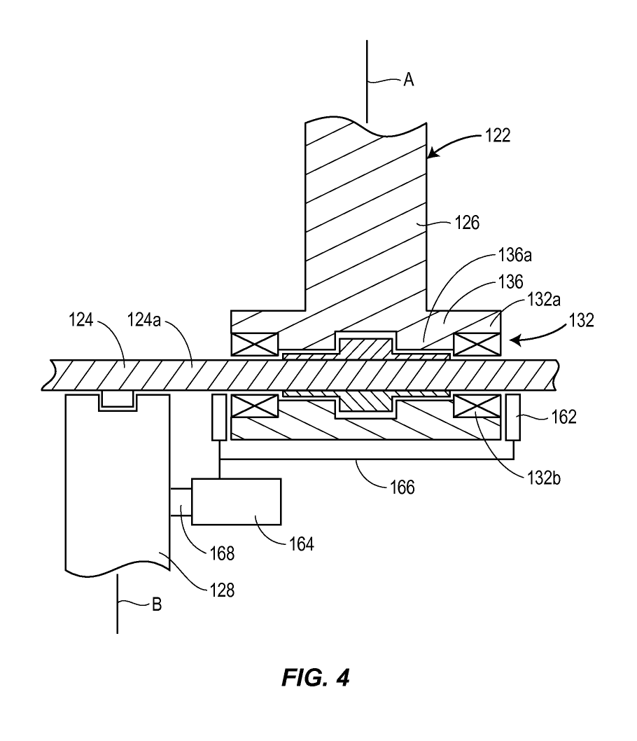

FIG. 4 shows a discontinuous shaft assembly 122 constructed in accordance with the teachings of another exemplary aspect of the present invention. As with the first disclosed example, the discontinuous shaft assembly 122 includes a first shaft 126, which may be the same or substantially similar to the first shaft 26 discussed above, and also includes a second shaft 128. The first shaft 126 includes a lower portion 136 terminating in an end 136a, and also carries a magnetic coupling 132. The magnetic coupling 132 includes an upper portion 132a carried by a lower end 136a of the shaft 126, and also includes a lower portion 132b rotatably mounted adjacent to the lower surface of the intervening wall 124a of the enclosure 124. In the example shown, an axis B of the shaft 128 is laterally offset from the axis A of the shaft 126. A hall effect sensor 162 is mounted adjacent to the lower portion 132b of the magnetic coupling 132. The hall effect sensor 162 is operatively coupled to a motor 164 via a suitable link 166, which may be wired or wireless. In turn, the motor 164 is operatively coupled to the shaft 128 via a suitable coupling 168. In all other respects, the discontinuous shaft assembly 122 may be the same or similar to the embodiment discussed above with respect to FIGS. 1, 2 and 3. Consequently, rotation of the first shaft 126 translates to rotation of the shaft 128. In accordance with exemplary aspect, this rotation is again transmitted across the walls of the enclosure 124 without requiring a penetration through the enclosure wall.

Any one or more of the examples discussed above, in any combination, may also be applied to a liquid level controller 210. Such a liquid level controller 210 is mounted outside of a vessel V, and typically receives inputs from a process element in the form of a displacer sensor 212 disposed on the inside of the vessel V. The vessel V is pressurized in some applications. In the example shown, movement of the displacer sensor 212 rotates a shaft 214, which is connected to conventional components carried by the liquid level controller 210. Using either one of the discontinuous shaft assemblies 22 or 122, or any combination thereof, rotation of the shaft 214 can be translated into appropriate rotation of a shaft (not shown) disposed inside the liquid level controller 210, enabling the liquid level controller 210 to convert the rotation into appropriate signals indicative of the state of a process fluid contained within the vessel V, and to transmit that information in the form of appropriate signals to the process control system as outlined above with respect to FIG. 1. Once again, rotation of the relevant shafts is transmitted across the walls of the vessel V without requiring a penetration through the vessel wall.

While certain representative embodiments and details have been shown for purposes of illustrating the invention, it will be apparent to those skilled in the art that various changes in the methods and apparatus disclosed herein may be made without departing from the scope of the invention.

1. A discontinuous shaft assembly for use with a field device, the field device including a wall, the discontinuous shaft assembly comprising:
a first shaft arranged for rotation about a first axis, the first shaft including an end arranged for placement adjacent the wall at a first desired location disposed on a first side of the wall;
a magnetic portion carried by the first shaft toward the end of the first shaft;
a second shaft, the second shaft arranged for rotation about a second axis, the second shaft including an end arranged for placement adjacent the wall of the enclosure at a second desired location disposed on a second side of the wall;
a magnetic portion carried by the second shaft toward the end of the second shaft;
the first magnetic portion arranged to cooperate with the second magnetic portion so that rotation of the first shaft about the first axis causes rotation of the second shaft about the second axis.

2. The discontinuous shaft assembly of claim 1, wherein the first shaft and the second shaft are arranged with the first axis in alignment with the second axis.

3. The discontinuous shaft assembly of claim 1, wherein the first shaft includes a first guide and the second shaft includes a second guide, and wherein the first guide is arranged to maintain the first shaft adjacent the first desired location and the second guide is arranged to maintain the second shaft adjacent the second desired location.

4. The discontinuous shaft assembly of claim 3, wherein the first guide engages the end of the first shaft, and wherein the second guide engages the end of the second shaft.

5. The discontinuous shaft assembly of claim 1, wherein the magnetic portion of the first shaft is radially offset relative to the first axis and the magnetic portion of the second shaft is radially offset relative to the second axis.

6. The discontinuous shaft assembly of claim 5, wherein the first shaft includes a base disposed at the end of the first shaft and the second shaft includes a base disposed at the end of the second shaft, and wherein the magnetic portion of the first shaft is carried by the base of the first shaft, and wherein the magnetic portion of the second shaft is carried by the base of the second shaft.

7. The discontinuous shaft assembly of claim 5, wherein the base of at least one of the first shaft or the second shaft is disc-shaped.

8. The discontinuous shaft assembly of claim 1, wherein the first magnetic portion comprises a first polarity and the second magnetic portion comprises a second polarity.

9. The discontinuous shaft assembly of claim 1, wherein the magnetic portion of the first shaft includes a first array of magnets and the magnetic portion of the second shaft includes a second array of magnets.

10. The discontinuous shaft assembly of claim 9, wherein, a first magnet in the first array of magnets has a polarity and is aligned with a corresponding second magnet of the second array of magnets, the corresponding second magnet having an opposite polarity from the first magnet.

11. A field device having a discontinuous shaft assembly, the field device comprising:
a controller operatively coupled to a first shaft, the controller operatively coupled to a process control system and an actuator;
a process element operatively coupled to a second shaft;
an enclosure having a wall, the actuator and the process control element disposed on opposite sides of the wall;
a first shaft arranged for rotation about a first axis, the first shaft including an end arranged for placement adjacent the wall at a first desired location disposed on a first side of the wall;
a magnetic portion carried by the first shaft toward the end of the first shaft;
a second shaft arranged for rotation about a second axis, the second shaft including an end arranged for placement adjacent the wall at a second desired location disposed on a second side of the wall;
a magnetic portion carried by the second shaft toward the end of the second shaft;
the magnetic portion of the first shaft arranged to cooperate with the magnetic portion of the second shaft so that rotation of either of the first shaft or the second shaft about its axis causes rotation of the second shaft or the first shaft, respectively, about its axis.

12. The field device of claim 11, wherein the enclosure is a pressure vessel.

13. The field device of claim 11, wherein the axis of the first shaft is aligned with the axis of the second shaft.

14. The field device of claim 11, wherein the first shaft is coupled to a first guide mounted to the first side of the wall, and the second shaft is coupled to a second guide mounted to the second side of the wall.

15. The field device of claim 14, wherein the first guide engages the end of the first shaft, and wherein the second guide engages the end of the second shaft.

16. The field device of claim 11, wherein the magnetic portion of the first shaft is radially offset relative to the first axis and the magnetic portion of the second shaft is radially offset relative to the second axis.

17. The field device of claim 16, wherein the first shaft includes a base disposed at the end of the first shaft and the second shaft includes a base disposed at the end of the second shaft, and wherein the magnetic portion of the first shaft is carried by the base of the first shaft, and wherein the magnetic portion of the second shaft is carried by the base of the second shaft, and wherein the base of at least one of the first shaft or the second shaft is disc-shaped.

18. The field device of claim 16, wherein the magnetic portion of the first shaft comprises a first polarity and the magnetic portion of the second shaft comprises a second polarity.

19. The field device of claim 16, wherein the first magnetic portion includes a first array of magnets and the second magnetic portion includes a second array of magnets.

20. The field device of claim 19, wherein, a first magnet in the first array of magnets has a polarity and is aligned with a corresponding second magnet of the second array of magnets, the corresponding second magnet having an opposite polarity from the first magnet.

21. A discontinuous shaft assembly for use with a field device, the field device including a wall, the discontinuous shaft assembly comprising:
a first shaft arranged for rotation about a first axis, the first shaft including an end arranged for placement adjacent the wall at a first desired location disposed on a first side of the wall;
a magnetic portion carried by the first shaft toward the end of the first shaft;
a second shaft, the second shaft arranged for rotation about a second axis, the second shaft including an end arranged for placement at a second desired location disposed on a second side of the wall;
a magnetic sensor disposed on the second side of the wall;
a motor operatively coupled to the second shaft and responsive to movement of the magnetic sensor;
the first magnetic portion arranged to cooperate with the magnetic sensor so that rotation of the first shaft about the first axis causes movement of the magnetic sensor, causing the motor to rotate the second shaft about the second axis.

22. The discontinuous shaft assembly of claim 21, wherein the axis of the first shaft is aligned with the axis of the second shaft.

23. The discontinuous shaft assembly of claim 21, wherein the axis of the first shaft is offset relative to the axis of the second shaft.

24. The discontinuous shaft assembly of claim 21, wherein the magnetic sensor comprises a hall effect sensor.
